(19) United States
(12) Patent Application Publication
(10) Pub. No.: US 2020/0079165 A1
(43) Pub. Date: Mar. 12, 2020

(54) HITCH ASSIST SYSTEM

(71) Applicant: Ford Global Technologies, LLC, Dearborn, MI (US)

(72) Inventors: Luke Niewiadomski, Dearborn, MI (US); Bruno Sielly Jales Costa, Sunnyvale, CA (US); Anjali Krishnamachar, Mountain View, CA (US); Douglas Rogan, Ferndale, MI (US)

(73) Assignee: Ford Global Technologies, LLC

(21) Appl. No.: 16/126,235

(22) Filed: Sep. 10, 2018

(51) Int. Cl. B60D 1/36; G05D 1/02

(52) U.S. Cl. CPC B60D 1/36; G05D 1/0231; B60D 1/06; G05D 1/0255; G05D 1/0257

(57) ABSTRACT

A hitch assist system is provided herein. The hitch assist system includes a sensing system having an imager and a proximity sensor. The hitch assist system also includes a controller for receiving signals from the proximity sensor and generating a feature map; determining a coupler location based on the detected features; and maneuvering the vehicle along a path to align a hitch ball with a coupler of the trailer.

### FIELD OF THE INVENTION

The present disclosure generally relates to autonomous and semi-autonomous vehicle systems, and more particularly, to hitch assist systems that facilitate the hitching of a vehicle to a trailer.

### BACKGROUND OF THE INVENTION

The process of hitching a vehicle to a trailer can be difficult, especially to those lacking experience. Accordingly, there is a need for a system that simplifies the process by assisting a user in a simple yet intuitive manner.

### SUMMARY OF THE INVENTION

According to some aspects of the present disclosure, a hitch assist system is provided herein. The hitch assist system includes a sensing system having an imager and a proximity sensor. The hitch assist system further includes a controller for receiving signals from the proximity sensor and generating a feature map; determining a coupler location based on detected features; and maneuvering a vehicle along a path to align a hitch ball with a coupler of a trailer.

According to some aspects of the present disclosure, a hitch assist method is provided herein. The method includes generating a grid map of features proximate a vehicle from one or more sensors disposed on the vehicle. The method also includes localizing and mapping two or more features relative to one another indicative of a trailer. The method further includes controlling a vehicle along a path to align a hitch ball with a coupler of the trailer.

According to some aspects of the present disclosure, a hitch assist system is provided herein. The hitch assist system includes an imager for capturing rear-vehicle images. The hitch assist system further includes a controller for creating an image patch of a scene rearwardly of the vehicle based on images provided by the imager; applying a parametric circle function to locate circular structures within the image patch; comparing an inputted value of a hitch ball diameter to a number of pixels within the circular structure to form a reference length; and utilizing the reference length to determine a ball mount length or a hitch ball height.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of a vehicle and a trailer, the vehicle being equipped with a hitch assistance system (also referred to as a “hitch assist” system), according to some examples;

FIG. 2 is a block diagram illustrating various components of the hitch assist system, according to some examples;

FIG. 3 is an overhead schematic view of the vehicle during a step of the alignment sequence with the trailer, according to some examples;

FIG. 4 is an overhead schematic view of the vehicle during a subsequent step of the alignment sequence with the trailer, according to some examples;

FIG. 5 is an overhead schematic view of the vehicle during a subsequent step of the alignment sequence with the trailer, according to some examples;

FIG. 6 is an overhead schematic view of the vehicle during a subsequent step of the alignment sequence with the trailer and showing the position of a hitch ball of the vehicle at an end of a derived alignment path, according to some examples;

FIG. 7 is an overhead schematic view of the vehicle having proximity sensors attached thereto, according to some examples;

FIG. 8 is an exemplary grid map of an area proximate the vehicle generated by the proximity sensors, according to some examples;

FIG. 9 is an enhanced view of area IX of FIG. 8;

FIG. 10 is a flowchart of a method of the hitch assist system, according to some examples;

FIG. 11 is a rear perspective view of the vehicle having an imager disposed within a rear portion thereof, according to some examples;

FIG. 12 is a representative image patch generated by the imager, according to some examples;

FIG. 13 is a rear side plan view of a vehicle having a hitch assembly operably coupled thereto, according to some examples;

FIG. 14 is a flowchart illustrating a method of determining various hitch assembly characteristics, according to some examples;

FIG. 15 is an exemplary graph illustrating a relationship between a hitch ball diameter and a ball to imager distance, according to some examples; and

FIG. 16 is an exemplary graph illustrating a relationship between a ball mount length and an imager-viewing angle, according to some examples.

### DETAILED DESCRIPTION OF THE PREFERRED EXAMPLES

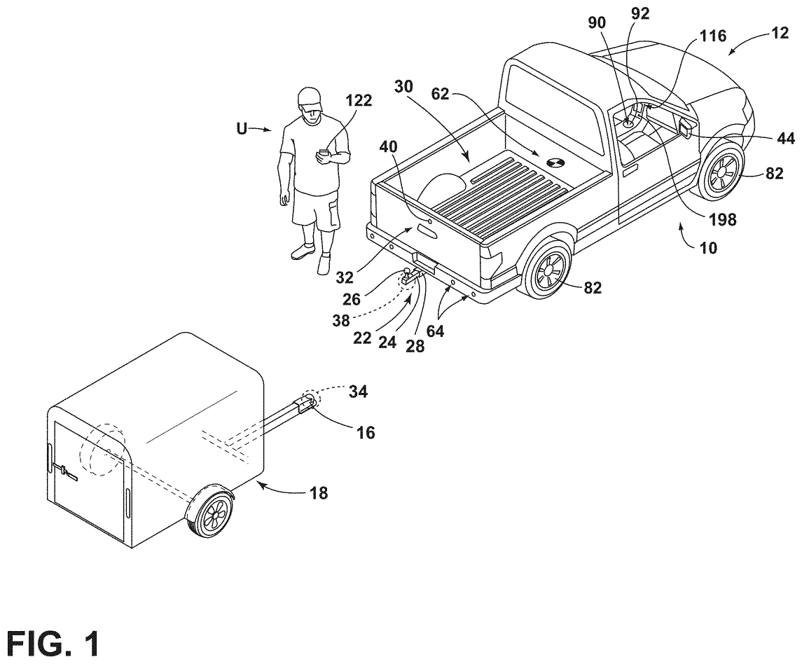

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, “visibility” is a measure of the distance at which an object or light can be clearly discerned. Accordingly, a low visibility condition may exist whenever the object or light is indiscernible from a threshold distance and a high visibility condition may exist whenever the object or light is discernible from the threshold distance. The object may be indiscernible due to night-like conditions (i.e., lower light level conditions) and/or atmospheric perturbations such as fog, rain, or any other particles in suspension that degrade the ability to discern an object from the threshold distance.

The following disclosure describes a hitch assist system for a vehicle. The hitch assist system may include a sensing system having an imager and a proximity sensor. The hitch assist system may also include a controller for receiving signals from the proximity sensor and generating a feature map; determining a coupler location based on the detected features; and maneuvering the vehicle along a path to align a hitch ball with a coupler of the trailer. In some examples, the hitch assist system may additionally and/or alternatively include an imager for capturing rear-vehicle images. The controller may be configured for creating an image patch of a scene rearwardly of the vehicle based on images provided by the imager; applying a parametric circle function to locate circular structures within the image patch; comparing an inputted value of a hitch ball diameter to a number of pixels within the circular structure to form a reference length; and utilizing the reference length to determine a ball mount length or a hitch ball height. It will be appreciated that the image patch may be formed from any number of pixels and that the pixels may each have a common dimension to one another. However, in alternate examples, the pixel dimensions may be varied without departing from the scope of the present disclosure.

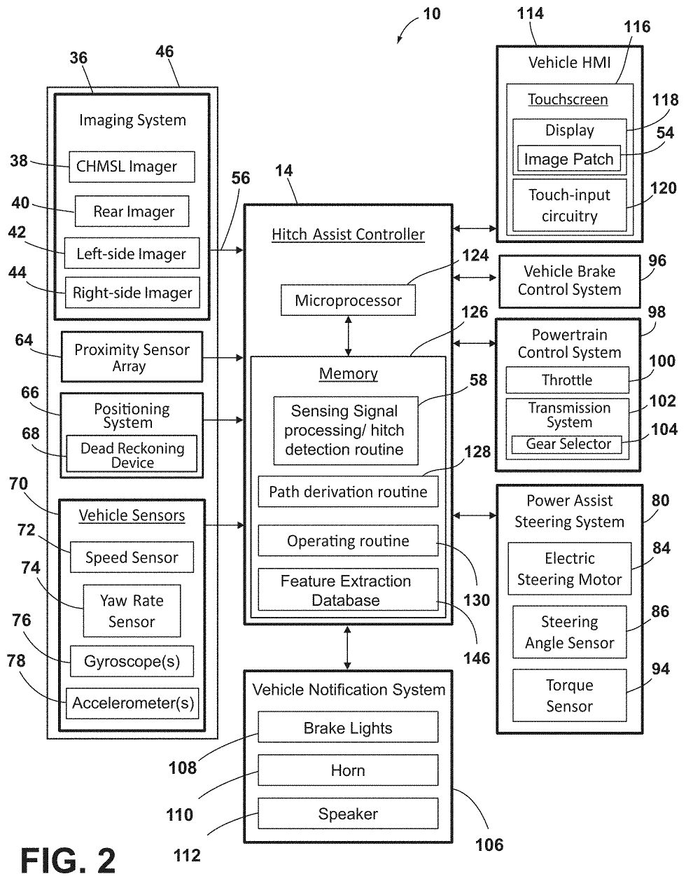

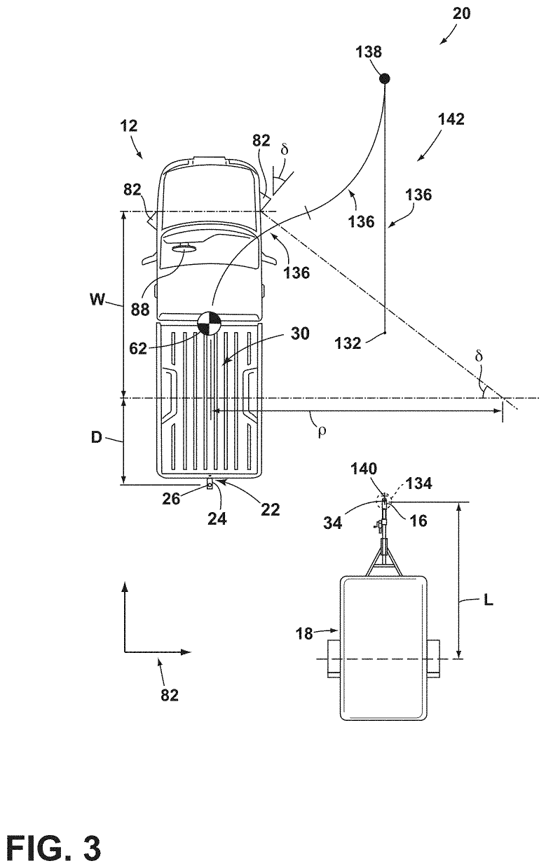

Referring to FIGS. 1 and 2, reference numeral 10 designates a hitch assist system for a vehicle 12. In particular, the hitch assist system 10 includes a controller 14 acquiring position data of a coupler 16 of a trailer 18 and deriving a vehicle path 20 (FIG. 3) to align a hitch assembly 22 of the vehicle 12 with the coupler 16. In some examples, the hitch assembly 22 may include a ball mount 24 supporting a hitch ball 26. The hitch ball 26 may be fixed on the ball mount 24 that extends from the vehicle 12 and/or the hitch ball 26 may be fixed to a portion of the vehicle 12, such as a bumper of the vehicle 12. In some examples, the ball mount 24 may couple with a receiver 28 that is fixed to the vehicle 12.

As shown in FIG. 1, the vehicle 12 is exemplarily embodied as a pickup truck having a truck bed 30 that is accessible via a rotatable tailgate 32. The hitch ball 26 may be received by a hitch coupler 16 in the form of a coupler ball socket 34 that is provided at a terminal end portion of the trailer coupler 16. The trailer 18 is exemplarily embodied as a single axle trailer from which the coupler 16 extends longitudinally. It will be appreciated that additional examples of the trailer 18 may alternatively couple with the vehicle 12 to provide a pivoting connection, such as by connecting with a fifth wheel connector. It is also contemplated that additional examples of the trailer 18 may include more than one axle and may have various shapes and sizes configured for different loads and items, such as a boat trailer or a flatbed trailer without departing from the teachings provided herein.

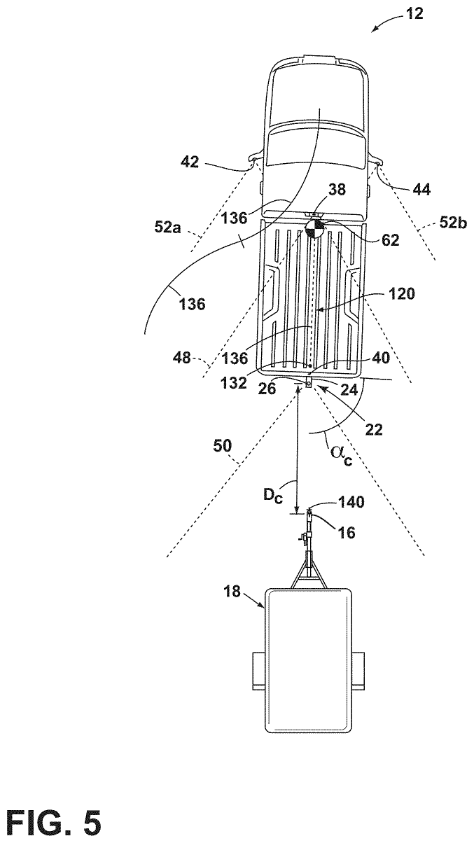

With respect to the general operation of the hitch assist system 10, as illustrated in FIG. 2, the hitch assist system 10 includes a sensing system 46 that includes various sensors and devices that obtain or otherwise provide vehicle status-related information. For example, in some instances, the sensing system 46 incorporates an imaging system 36 that includes one or more exterior imagers 38, 40, 42, 44, or any other vision-based device. The one or more imagers 38, 40, 42, 44 each include an area-type image sensor, such as a CCD or a CMOS image sensor, and image-capturing optics that capture an image of an imaging field of view (e.g., fields of view 48, 50, 52a, 52b, FIG. 5) defined by the image-capturing optics. In some instances, the one or more imagers 38, 40, 42, 44 may derive an image patch 54 from multiple image frames that may be shown on a display 118. In various examples, the hitch assist system 10 may include any one or more of a center high-mount stop light (CHMSL) imager 38, a rear imager 40, a left-side side-view imager 42, and/or a right-side side-view imager 44, although other arrangements including additional or alternative imagers are possible without departing from the scope of the present disclosure.

In some examples, the imaging system 36 can include the rear imager 40 alone or can be configured such that the hitch assist system 10 utilizes only the rear imager 40 in a vehicle 12 with the multiple exterior imagers 38, 40, 42, 44. In some instances, the various imagers 38, 40, 42, 44 included in the imaging system 36 can be positioned to generally overlap in their respective fields of view, which in the depicted arrangement of FIG. 5 includes fields of view 48, 50, 52a, 52b to correspond with the CHMSL imager 38, the rear imager 40, and the side-view imagers 42 and 44, respectively. In this manner, image data 56 from two or more of the imagers 38, 40, 42, 44 can be combined in an image/signal processing routine 58, or in another dedicated image/signal processor within the imaging system 36, into a single image or image patch 54. In an extension of such examples, the image data 56 can be used to derive stereoscopic image data 56 that can be used to reconstruct a three-dimensional scene of the area or areas within overlapped areas of the various fields of view 48, 50, 52a, 52b, including any objects (e.g., obstacles or the coupler 16) therein.

In some examples, the use of two images including the same object can be used to determine a location of the object relative to the two imagers 38, 40, 42, and/or 44, given a known spatial relationship between the imagers 38, 40, 42, 44 through projective geometry of the imagers 38, 40, 42, 44. In this respect, the image/signal processing routine 58 can use known programming and/or functionality to identify an object within the image data 56 from the various imagers 38, 40, 42, 44 within the imaging system 36. The image/signal processing routine 58 can include information related to the positioning of any of the imagers 38, 40, 42, 44 present on the vehicle 12 or utilized by the hitch assist system 10, including relative to a center 62 (FIG. 1) of the vehicle 12. For example, the positions of the imagers 38, 40, 42, 44 relative to the center 62 of the vehicle 12 and/or to each other can be used for object positioning calculations and to result in object position data relative to the center 62 of the vehicle 12, for example, or other features of the vehicle 12, such as the hitch ball 26 (FIG. 1), with known positions relative to the center 62 of the vehicle 12 in a manner similar to that which is described in commonly assigned U.S. patent application Ser. No. 15/708,427, filed Sep. 19, 2017, and entitled “HITCH ASSIST SYSTEM WITH HITCH COUPLER IDENTIFICATION FEATURE AND HITCH COUPLER HEIGHT ESTIMATION,” the entire disclosure of which is incorporated by reference herein.

With further reference to FIGS. 1 and 2, a proximity sensor 60 or an array thereof, and/or other vehicle sensors 70, may provide sensor signals that the controller 14 of the hitch assist system 10 processes with various routines to determine various objects proximate the vehicle 12, the trailer 18, and/or the coupler 16 of the trailer 18. The proximity sensor 60 may also be utilized to determine a height and position of the coupler 16. The proximity sensor 60 may be configured as any type of sensor, such as an ultrasonic sensor, a radio detection and ranging (radar) sensor, a sound navigation and ranging (SONAR) sensor, a light detection and ranging (LIDAR) sensor, a vision-based sensor, and/or any other type of sensor known in the art.

Referring still to FIGS. 1 and 2, a positioning system 66, may include a dead reckoning device 68 or, in addition, or as an alternative, a global positioning system (GPS) that determines a coordinate location of the vehicle 12. For example, the dead reckoning device 68 can establish and track the coordinate location of the vehicle 12 within a localized coordinate system based at least on vehicle speed and/or steering angle δ (FIG. 3). The controller 14 may also be operably coupled with various vehicle sensors 70, such as a speed sensor 72 and a yaw rate sensor 74. Additionally, the controller 14 may communicate with one or more gyroscopes 76 and accelerometers 78 to measure the position, orientation, direction, and/or speed of the vehicle 12.

To enable autonomous or semi-autonomous control of the vehicle 12, the controller 14 of the hitch assist system 10 may be further configured to communicate with a variety of vehicle systems. According to some examples, the controller 14 of the hitch assist system 10 may control a power assist steering system 80 of the vehicle 12 to operate the steered road wheels 82 of the vehicle 12 while the vehicle 12 moves along a vehicle path 20. The power assist steering system 80 may be an electric power-assisted steering (EPAS) system that includes an electric steering motor 84 for turning the steered road wheels 82 to a steering angle δ based on a steering command generated by the controller 14, whereby the steering angle δ may be sensed by a steering angle sensor 86 of the power assist steering system 80 and provided to the controller 14. As described herein, the steering command may be provided for autonomously steering the vehicle 12 during a maneuver and may alternatively be provided manually via a rotational position (e.g., a steering wheel angle) of a steering wheel 88 (FIG. 3) or a steering input device 90, which may be provided to enable a driver to control or otherwise modify the desired curvature of the path 20 of vehicle 12. The steering input device 90 may be communicatively coupled to the controller 14 in a wired or wireless manner and provides the controller 14 with information defining the desired curvature of the path 20 of the vehicle 12. In response, the controller 14 processes the information and generates corresponding steering commands that are supplied to the power assist steering system 80 of the vehicle 12. In some examples, the steering input device 90 includes a rotatable knob 92 operable between a number of rotated positions that each provides an incremental change to the desired curvature of the path 20 of the vehicle 12.

In some examples, the steering wheel 88 of the vehicle 12 may be mechanically coupled with the steered road wheels 82 of the vehicle 12, such that the steering wheel 88 moves in concert with steered road wheels 82 via an internal torque during autonomous steering of the vehicle 12. In such instances, the power assist steering system 80 may include a torque sensor 94 that senses torque (e.g., gripping and/or turning) on the steering wheel 88 that is not expected from the autonomous control of the steering wheel 88 and therefore is indicative of manual intervention by the driver. In some examples, the external torque applied to the steering wheel 88 may serve as a signal to the controller 14 that the driver has taken manual control and for the hitch assist system 10 to discontinue autonomous steering functionality. However, as provided in more detail below, the hitch assist system 10 may continue one or more functions/operations while discontinuing the autonomous steering of the vehicle.

The controller 14 of the hitch assist system 10 may also communicate with a vehicle brake control system 96 of the vehicle 12 to receive vehicle speed information such as individual wheel speeds of the vehicle 12. Additionally or alternatively, vehicle speed information may be provided to the controller 14 by a powertrain control system 98 and/or the vehicle speed sensor 72, among other conceivable means. The powertrain control system 98 may include a throttle 100 and a transmission system 102. A gear selector 104 may be disposed within the transmission system 102 that controls the mode of operation of the vehicle transmission system 102 through one or more gears of the transmission system 102. In some examples, the controller 14 may provide braking commands to the vehicle brake control system 96, thereby allowing the hitch assist system 10 to regulate the speed of the vehicle 12 during a maneuver of the vehicle 12. It will be appreciated that the controller 14 may additionally or alternatively regulate the speed of the vehicle 12 via interaction with the powertrain control system 98.

Through interaction with the power assist steering system 80, the vehicle brake control system 96, and/or the powertrain control system 98 of the vehicle 12, the potential for unacceptable conditions can be reduced when the vehicle 12 is moving along the path 20. Examples of unacceptable conditions include, but are not limited to, a vehicle over-speed condition, sensor failure, and the like. In such circumstances, the driver may be unaware of the failure until the unacceptable backup condition is imminent or already happening. Therefore, it is disclosed herein that the controller 14 of the hitch assist system 10 can generate an alert signal corresponding to a notification of an actual, impending, and/or anticipated unacceptable backup condition, and prior to driver intervention, generate a countermeasure to prevent such an unacceptable backup condition.

According to some examples, the controller 14 may communicate with one or more devices, including a vehicle notification system 106, which may prompt visual, auditory, and tactile notifications and/or warnings. For instance, vehicle brake lights 108 and/or vehicle emergency flashers may provide a visual alert. A vehicle horn 110 and/or speaker 112 may provide an audible alert. Additionally, the controller 14 and/or vehicle notification system 106 may communicate with a user-input device, such as a human-machine interface (HMI) 114 of the vehicle 12. The HMI 114 may include a touchscreen 116, or other user-input device, such as a navigation and/or entertainment display 118 mounted within a cockpit module, an instrument cluster, and/or any other location within the vehicle 12, which may be capable of displaying images, indicating the alert.

In some instances, the HMI 114 further includes an input device, which can be implemented by configuring the display 118 as a portion of the touchscreen 116 with circuitry 120 to receive an input corresponding with a location over the display 118. Other forms of input, including one or more joysticks, digital input pads, or the like can be used in place or in addition to touchscreen 116.

Further, the hitch assist system 10 may communicate via wired and/or wireless communication with some instances of the HMI 114 and/or with one or more handheld or portable devices 122 (FIG. 1), which may additionally and/or alternatively be configured as the user-input device. The network may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services.

The portable device 122 may also include the display 118 for displaying one or more images and other information to a user U. For instance, the portable device 122 may display one or more images of the trailer 18 on the display 118 and may be further able to receive remote user inputs via touchscreen circuitry 120. In addition, the portable device 122 may provide feedback information, such as visual, audible, and tactile alerts. It will be appreciated that the portable device 122 may be any one of a variety of computing devices and may include a processor and memory. For example, the portable device 122 may be a cell phone, mobile communication device, key fob, wearable device (e.g., fitness band, watch, glasses, jewelry, wallet), apparel (e.g., a tee shirt, gloves, shoes or other accessories), personal digital assistant, headphones and/or other devices that include capabilities for wireless communications and/or any wired communications protocols.

The controller 14 is configured with a microprocessor 124 and/or other analog and/or digital circuitry for processing one or more logic routines stored in a memory 126. The logic routines may include one or more routines including the image/signal processing routine 58, a hitch detection routine, a path derivation routine 128, and an operating routine 130. Information from the imager 40 or other components of the sensing system 46 can be supplied to the controller 14 via a communication network of the vehicle 12, which can include a controller area network (CAN), a local interconnect network (LIN), or other protocols used in the automotive industry. It will be appreciated that the controller 14 may be a stand-alone dedicated controller or may be a shared controller integrated with the imager 40 or other component of the hitch assist system 10 in addition to any other conceivable onboard or off-board vehicle control systems.

The controller 14 may include any combination of software and/or processing circuitry suitable for controlling the various components of the hitch assist system 10 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and so forth. All such computing devices and environments are intended to fall within the meaning of the term “controller” or “processor” as used herein unless a different meaning is explicitly provided or otherwise clear from the context.

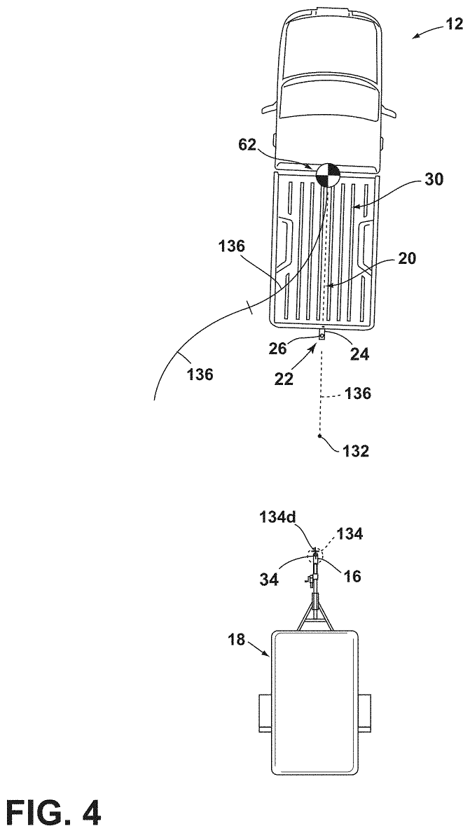

With further reference to FIGS. 2-6, the controller 14 may generate vehicle steering information and commands as a function of all or a portion of the information received. Thereafter, the vehicle steering information and commands may be provided to the power assist steering system 80 for effecting the steering of the vehicle 12 to achieve a commanded path 20 of travel for alignment with the coupler 16 of the trailer 18. It will further be appreciated that the image/signal processing routine 58 may be carried out by a dedicated processor, for example, within a stand-alone imaging system 36 for the vehicle 12 that can output the results of its image/signal processing to other components and systems of vehicle 12, including the microprocessor 124. Further, any system, computer, processor, or the like that completes image/signal processing functionality, such as that described herein, may be referred to herein as an “image/signal processor” regardless of other functionality it may also implement (including simultaneously with executing the image/signal processing routine 58).

In some examples, the image/signal processing routine 58 can be programmed or otherwise configured to locate the coupler 16 within the image data 56. In some instances, the image/signal processing routine 58 can identify the coupler 16 within the image data 56 based on stored or otherwise known visual characteristics of the coupler 16 or hitches in general. In some instances, a marker in the form of a sticker or the like may be affixed with trailer 18 in a specified position relative to coupler 16 in a manner similar to that which is described in commonly assigned U.S. Pat. No. 9,102,271, entitled “TRAILER MONITORING SYSTEM AND METHOD,” the entire disclosure of which is incorporated by reference herein. In such examples, the image/signal processing routine 58 may be programmed with identifying characteristics of the marker for location in the image data 56, as well as the positioning of the coupler 16 relative to such a marker so that the location of the coupler 16 can be determined based on the marker location. Additionally or alternatively, the controller 14 may seek confirmation of the coupler 16, via a prompt on the touchscreen 116 and/or the portable device 122. If the coupler 16 determination is not confirmed, further image/signal processing may be provided, or user-adjustment of the position 134 of the coupler 16 may be facilitated, either using the touchscreen 116 or another input to allow the user U to move the depicted position 134 of the coupler 16 on the touchscreen 116, which the controller 14 uses to adjust the determination of the position 134 of the coupler 16 with respect to the vehicle 12 based on the above-described use of the image data 56. Alternatively, the user U can visually determine the position 134 of the coupler 16 within an image presented on HMI 114 and can provide a touch input in a manner similar to that which is described in co-pending, commonly-assigned U.S. patent application Ser. No. 15/583,014, filed May 1, 2017, and entitled “SYSTEM TO AUTOMATE HITCHING A TRAILER,” the entire disclosure of which is incorporated by reference herein. The image/signal processing routine 58 can then correlate the location of the touch input with the coordinate system applied to the image patch 54.

As shown in FIGS. 3-6, in some exemplary instances of the hitch assist system 10, the image/signal processing routine 58 and operating routine 130 may be used in conjunction with each other to determine the path 20 along which the hitch assist system 10 can guide the vehicle 12 to align the hitch ball 26 and the coupler 16 of the trailer 18. In the example shown, an initial position of the vehicle 12 relative to the trailer 18 may be such that the coupler 16 is in the field of view 52a of the side imager 42, with the vehicle 12 being positioned latitudinally from the trailer 18 but with the coupler 16 being almost longitudinally aligned with the hitch ball 26. In this manner, upon initiation of the hitch assist system 10, such as by user input on the touchscreen 116, for example, the image/signal processing routine 58 can identify the coupler 16 within the image data 56 of the imager 42 and estimate the position 134 of the coupler 16 relative to the hitch ball 26 using the image data 56 in accordance with the examples discussed above or by other known means, including by receiving focal length information within image data 56 to determine a distance D_{c} to the coupler 16 and an angle α_{c} of offset between the coupler 16 and the longitudinal axis of vehicle 12. Once the positioning D_{c}, α_{c} of the coupler 16 has been determined and, optionally, confirmed by the user U, the controller 14 can take control of at least the vehicle steering system 80 to control the movement of the vehicle 12 along the desired path 20 to align the vehicle hitch ball 26 with the coupler 16.

Continuing with reference to FIG. 3, the controller 14 (FIG. 2), having estimated the positioning D_{c}, α_{c} of the coupler 16, as discussed above, can, in some examples, execute the path derivation routine 128 to determine the vehicle path 20 to align the vehicle hitch ball 26 with the coupler 16. The controller 14 can store various characteristics of vehicle 12, including a wheelbase W, a distance D from the rear axle to the hitch ball 26, which is referred to herein as the drawbar length, as well as a maximum angle to which the steered wheels 82 can be turned δₘₐₓ. As shown, the wheelbase W and the current steering angle δ can be used to determine a corresponding turning radius ρ for the vehicle 12 according to the equation:

$$ρ = \frac{1}{W tan δ} , \qquad ( 1 )$$

in which the wheelbase W is fixed and the steering angle δ can be controlled by the controller 14 by communication with the steering system 80, as discussed above. In this manner, when the maximum steering angle δₘₐₓ is known, the smallest possible value for the turning radius ρₘᵢₙ is determined as:

$${ρ}_{min} = \frac{1}{W tan {δ}_{max}} . \qquad ( 2 )$$

The path derivation routine 128 can be programmed to derive the vehicle path 20 to align a known location of the vehicle hitch ball 26 with the estimated position 134 of the coupler 16 that takes into account the determined minimum turning radius ρₘᵢₙ, which may allow the path 20 to use the minimum amount of space and maneuvers. In this manner, the path derivation routine 128 can use the position of the vehicle 12, which can be based on the center 62 of the vehicle 12, a location along the rear axle, the location of the dead reckoning device 68, or another known location on the coordinate system, to determine both a lateral distance to the coupler 16 and a forward or rearward distance to coupler 16 and derive the path 20 that achieves lateral and/or forward-backward movement of the vehicle 12 within the limitations of the steering system 80. The derivation of the path 20 further takes into account the positioning of the hitch ball 26 relative to the tracked location of vehicle 12 (which may correspond with the center 62 of mass of the vehicle 12, the location of a GPS receiver, or another specified, known area) to determine the needed positioning of the vehicle 12 to align the hitch ball 26 with the coupler 16.

Once the projected path 20, including the endpoint 132, has been determined, the controller 14 may at least control the steering system 80 of the vehicle 12 with the powertrain control system 98 and the brake control system 96 (whether controlled by the driver or by the controller 14) controlling the speed (forward or rearward) of the vehicle 12. In this manner, the controller 14 can receive data regarding the position of the vehicle 12 during movement thereof from the positioning system 66 while controlling the steering system 80 to maintain the vehicle 12 along the path 20. The path 20, having been determined based on the vehicle 12 and the geometry of steering system 80, can adjust the steering angle δ, as dictated by the path 20, depending on the position of the vehicle 12 therealong.

As illustrated in FIG. 3, the initial positioning of the trailer 18 relative to the vehicle 12 may be such that forward movement of vehicle 12 is needed for the desired vehicle path 20, such as when the trailer 18 is latitudinally offset to the side of vehicle 12. In this manner, the path 20 may include various segments 136 of forward driving and/or rearward driving of the vehicle 12 separated by inflection points 138 at which the vehicle 12 transitions between forward and rearward movement. As used herein, “inflection points” are any point along the vehicle path 20 in which a vehicle condition is changed. The vehicle conditions include, but are not limited to, a change in speed, a change in steering angle δ, a change in vehicle direction, and/or any other possible vehicle condition that may be adjusted. For example, if a vehicle speed is altered, an inflection point 138 may be at the location where the speed was altered. In some examples, the path derivation routine 128 can be configured to include a straight backing segment 136 for a defined distance before reaching the point at which the hitch ball 26 is aligned with the position 134 of the coupler 16. The remaining segments 136 can be determined to achieve the lateral and forward/backward movement within the smallest area possible and/or with the lowest number of overall segments 136 or inflection points 138. In the illustrated example of FIG. 3, the path 20 can include two segments 136 that collectively traverse the lateral movement of the vehicle 12, while providing a segment 136 of straight rearward backing to bring the hitch ball 26 into an offset position 134 of the coupler 16, one of which includes forward driving with a maximum steering angle δₘₐₓ in the rightward-turning direction and the other including forward driving with a maximum steering angle δₘₐₓ in the leftward-turning direction. Subsequently, an inflection point 138 is included in which the vehicle 12 transitions from forward driving to rearward driving followed by the previously-mentioned straight rearward backing segment 136. It is noted that variations in the depicted path 20 may be used, including a variation with a single forward-driving segment 136 at a rightward steering angle δ less than the maximum steering angle δₘₐₓ, followed by an inflection point 138 and a rearward driving segment 136 at a maximum leftward steering angle δₘₐₓ with a shorter straight backing segment 136, with still further paths 20 being possible.

In some instances, the hitch assist system 10 may be configured to operate with the vehicle 12 in reverse only, in which case, the hitch assist system 10 can prompt the driver to drive vehicle 12, as needed, to position the trailer 18 in a designated area relative to the vehicle 12, including to the rear thereof so that path derivation routine 128 can determine a vehicle path 20 that includes rearward driving. Such instructions can further prompt the driver to position the vehicle 12 relative to the trailer 18 to compensate for other limitations of the hitch assist system 10, including a particular distance for identification of the coupler 16, a minimum offset angle α_{c}, or the like. It is further noted that the estimates for the positioning D_{c}, α_{c} of the coupler 16 may become more accurate as the vehicle 12 traverses the path 20, including to position the vehicle 12 in front of the trailer 18 and as the vehicle 12 approaches the coupler 16. Accordingly, such estimates can be derived and used to update the path derivation routine 128, if desired, in the determination of the adjusted initial endpoint 132 for the path 20.

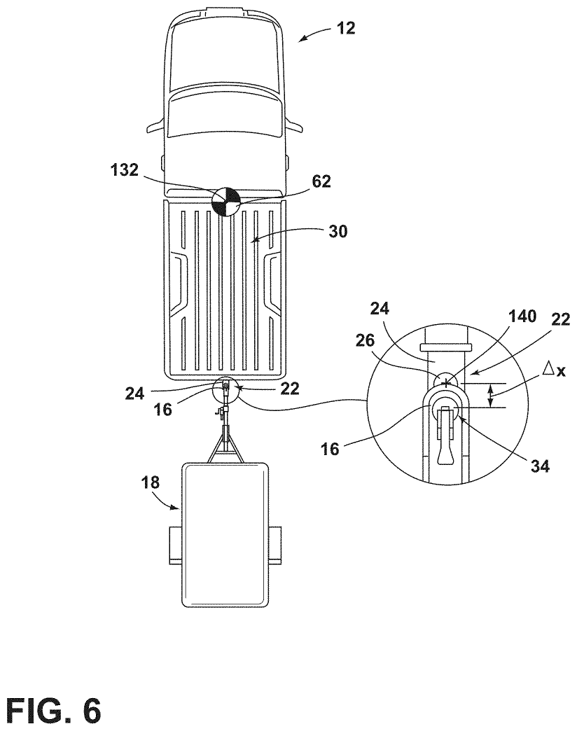

Referring to FIGS. 5 and 6, a strategy for determining an initial endpoint 132 for the vehicle path 20 that places hitch ball 26 in a projected position for alignment with the coupler 16 involves calculating the actual or an approximate trajectory for movement of the coupler 16 while lowering the coupler 16 onto the hitch ball 26. The initial endpoint 132 is then derived, as discussed above or otherwise, to place hitch ball 26 at the desired location 140 on that trajectory. In effect, such a scheme is implemented by determining the difference between the height H_{c} of the coupler 16 and the height H_{hb} of the hitch ball 26, which represents the vertical distance by which coupler 16 will be lowered to engage with hitch ball 26. The determined trajectory is then used to relate the vertical distance with a corresponding horizontal distance Δx of coupler 16 movement in the driving direction that results from the vertical distance. This horizontal distance Δx can be input into the path derivation routine 128 as the desired initial endpoint 132 thereof or can be applied as an offset to the initial endpoint 132 derived from the initially determined position 134 of the coupler 16 when the path 20 ends with the straight-backing segment 136, as illustrated in FIG. 3.

Referring again to FIGS. 5 and 6, the operating routine 130 may continue to guide the vehicle 12 until the hitch ball 26 is in the desired final endpoint 140 relative to the coupler 16 for the coupler 16 to engage with the hitch ball 26 when the coupler 16 is lowered into alignment and/or engagement therewith. In the examples discussed above, the image/signal processing routine 58 monitors the positioning D_{c}, α_{c} of the coupler 16 during execution of the operating routine 130, including as the coupler 16 comes into clearer view of the rear imager 40 with continued movement of the vehicle 12 along the path 20. As discussed above, the position of the vehicle 12 can also be monitored by the dead reckoning device 68 with the position 134 of the coupler 16 being updated and fed into the path derivation routine 128 in case the path 20 and/or the initial endpoint 132 can be refined or should be updated (due to, for example, improved height H_{c}, distance D_{c}, or offset angle α_{c} information due to closer resolution or additional image data 56), including as the vehicle 12 moves closer to the trailer 18. In some instances, the coupler 16 can be assumed static such that the position of the vehicle 12 can be tracked by continuing to track the coupler 16 to remove the need for use of the dead reckoning device 68. In a similar manner, a modified variation of the operating routine 130 can progress through a predetermined sequence of maneuvers involving steering of the vehicle 12 at or below a maximum steering angle δₘₐₓ, while tracking the position D_{c}, α_{c} of the coupler 16 to converge the known relative position of the hitch ball 26 to the desired final endpoint 140 thereof relative to the tracked position 134 of the coupler 16.

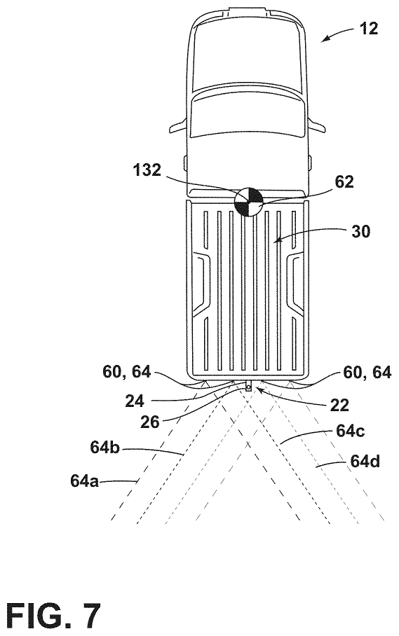

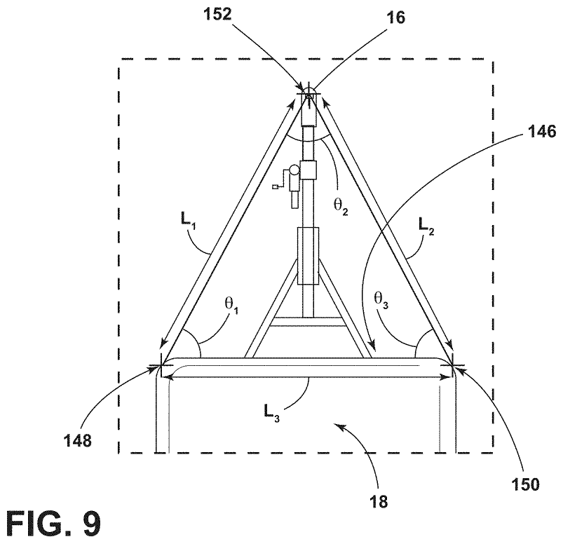

Referring to FIGS. 7-9, in some environments, snow, rain and/or other obscurants may lessen the accuracy of vehicle sensors that operate at a wavelength in the 400 to 900 μm size range, such as imagers 38, 40, 42, 44, as the waves produced by such sensors may be at least partially blocked by the obscurants. Accordingly, in some examples, the hitch assist system 10 may utilize proximity sensors, such as radar sensors 64 that can operate successfully through most snow, rain or dust without substantial effect to detect the trailer 18 and/or the coupler 16. The proximity sensors may also be used to detect other various objects proximate the vehicle 12 during operation of the hitch assist system 10 prior to and/or during any hitch assist operations. It will be appreciated that any other sensor capable of providing information to the hitch assist system 10 during high and/or low visibility conditions may be used in conjunction with or in lieu of the radar sensor 64.

In general, the radar sensors 64 operate by transmitting radio signals and detecting reflections off objects. In some examples, the radar sensors 64 may be used to detect physical objects, such as the trailer 18 (or portions of the trailer 18), the coupler 16, other vehicles, landscapes (such as trees, cliffs, rocks, hills, or the like), road edges, signs, buildings, or other objects. The radar sensors 64 may use reflected radio waves to determine a size, shape, distance, surface texture, or other information about a physical object or material.

With further reference to FIGS. 7-9, the radar sensors 64 may sweep an area to obtain data on objects within a field of view 64a, 64b, 64c, 64d of the radar sensors 64 having a predefined range and viewing angle. In some examples, the radar sensors 64 are configured to generate perception information from a region near the vehicle 12, such as one or more regions nearby or surrounding the rear portion of the vehicle 12. In some examples, the radar sensors 64 may provide perception data including a two-dimensional or three-dimensional map or model to the hitch assist system 10 for reference or processing. Moreover, the radar sensors 64 can operate in some of the most severe and adverse weather conditions and/or in night-like conditions with little or no degradation in the quality or accuracy of perception data. For example, wet surfaces, snow, and fog may have little impact on an ability of the radar sensors 64 to accurately locate and detect ranges to objects. Accordingly, in some instances, the radar sensors 64 may be used as a secondary detection system in high visibility environments and as a primary detection system when the vehicle 12 is operated in a low visibility environment.

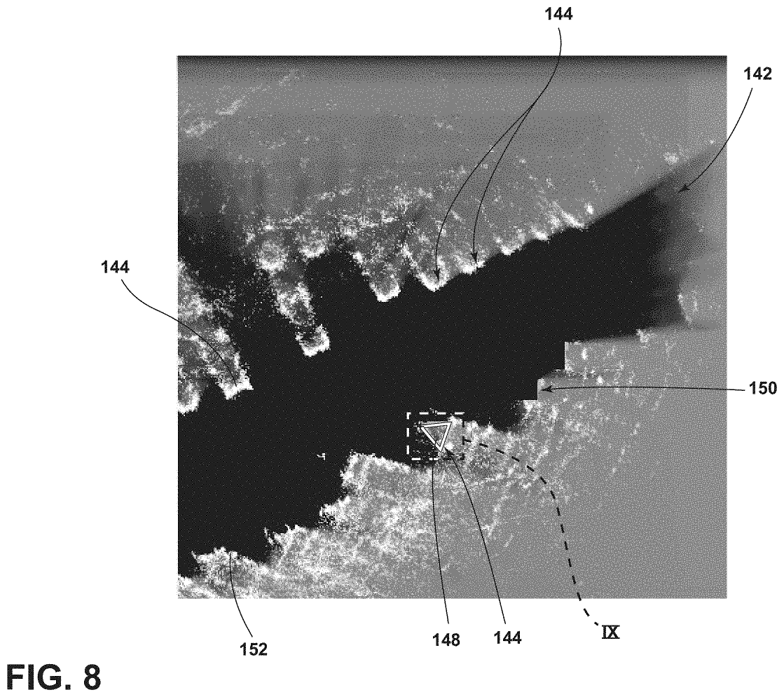

In some instances, as exemplarily illustrated in FIG. 8, an environmental occupancy grid map 142, formed by an environmental occupancy grid abstraction that may be defined in Cartesian coordinates relative to the vehicle's orientation such that, for example, the X-axis is vehicle side-to-side, the Y-axis is vehicle forward/rearward, and the Z-axis is up, may be generated from the received proximity sensor signals. It will be appreciated that the coordinate system may be cylindrical coordinates with a range, angle, and height relative to the vehicle's current orientation and/or the occupancy grids 142 may be translated to other coordinate systems for use by an operator without departing from the teachings provided herein.

The occupancy grid map 142 may be developed by dividing the environment into a discrete grid of occupancy cells and assigning a probability to each grid indicating whether the grid is occupied by an object. Initially, the occupancy grid may be set so that every occupancy cell is set to an initial probability. As the vehicle 12, through the sensing system 46, scans the environment, range data developed from the scans may be used to update the occupancy grid. For example, based on range data, the vehicle 12 may detect an object at a specific orientation and range away from the vehicle 12. This range data may be converted to a different coordinate system (e.g., local or world Cartesian coordinates). As a result of this detection, the vehicle 12 may increase the probability that the particular occupancy cell is occupied and decrease the probability that occupancy cells between the vehicle 12 and the detected object are occupied. As the vehicle 12 moves through its environment, new horizons may be exposed to the vehicles sensors, which enable the occupancy grid to be expanded and enhanced.

In some examples, the controller 14 monitors the environment proximate the vehicle 12 as proximity sensor signals are provided. Next, areas in the occupancy grid map 142, or in the image patch 54 in examples that additionally and/or alternatively use imagers 38, 40, 42, 44, are analyzed and features 144 or patterns in the data indicative of an object in the grid map 142 and/or image patch 54 are extracted. The extracted features 144 are then classified according to any number of classifiers. An exemplary classification can include classification as a trailer 18, a coupler 16, a moving object, such as another vehicle, and/or a stationary object, such as a street sign. Data including the classification is then analyzed according to data association in order to form a feature extraction database 146 (FIG. 2). The data of the feature extraction database 146 is then stored for iterative comparison to new data and for prediction of a likelihood that a trailer 18 is proximate the vehicle 12. The controller 14 may compute the features 144 of the feature extraction database 146 using the following transforms: edge, histogram of gradient orientation (HOG), scale-invariant feature transform (SIFT), Harris corner detectors, the patches projected onto a linear subspace, and/or any other practicable transform or detector algorithm. In some examples, machine learning algorithms can be used to adaptively utilize programming, assigning weights and emphasis to alternative calculations depending upon the nature of feedback. Additionally, fuzzy logic can be utilized to condition inputs to a system according to scalable factors based upon feedback. In this way, accuracy of the system can be improved over time and based upon the particular driving habits of an operator.

Still referring to FIGS. 7-9, in some examples, through usage of the sensing system 46, the hitch assist system 10 may be configured to perform simultaneous localization and mapping (SLAM) from the sensor signals to determine the position and the alignment of the vehicle 12 relative to the trailer 18 and/or the coupler 16. SLAM is understood in the present disclosure as a problem in which initially both the position and the alignment of the vehicle 12 are unknown relative to the trailer 18, and/or any other obstacle. When solving the SLAM problem, the position and alignment of the vehicle 12 and the position of the trailer 18 and/or the coupler 16 may be determined simultaneously.

In some examples, the various proximity sensors included in the sensing system 46 can be positioned to generally overlap in their respective fields of view, which in the depicted arrangement of FIG. 7 includes fields of view 64a, 64b, 64c, 64d. In this manner, sensor signals from two or more of the proximity sensors 60 can be combined in the image/signal processing routine 58, or in another dedicated image/signal processor within the sensing system 46, into a global frame. In an extension of such examples, the sensor signals can be used to derive stereoscopic data that can be used to reconstruct a three-dimensional scene of the area or areas within overlapped areas of the various fields of view 64a, 64b, 64c, 64d, including any objects (e.g., obstacles or the coupler 16) therein.

In some instances, the trailer 18 may include a pair of points 148, 150 that correspond with front outer corners, or other outer shapes, of the trailer 18. The hitch coupler 16 may be centrally disposed between the pair of points 148, 150 or outer corners at a forward portion 146 of the trailer 18. Accordingly, the hitch assist system 10 may detect these points 148, 150, or any other desired points, that may be found on the trailer 18 and therefore recognizable within the SLAM problem. Once these points 148, 150, 152 are determined, recognized, localized, and/or mapped relative a global frame that may be based off the center 62 of the vehicle 12, or any other coordinate system, the length L₁ from the coupler 16 to a first point 148 or corner, the length L₂ from the coupler 16 to a second point 150 or corner, and the length L₃ between the first and second points 148, 150 or corners can be used to determine a shape of the trailer 18, a coupler position, and/or a heading direction of the trailer 18 relative the vehicle 12 according to the equations:

L₁²=L₂²+L₃²−2L₂L₃cosθ₁, (3)

L₂²=L₁²+L₃²−2L₁L₃cosθ₂, and (4)

L₃²=L₁²+L₂²−2L₁L₂cosθ₃. (5)

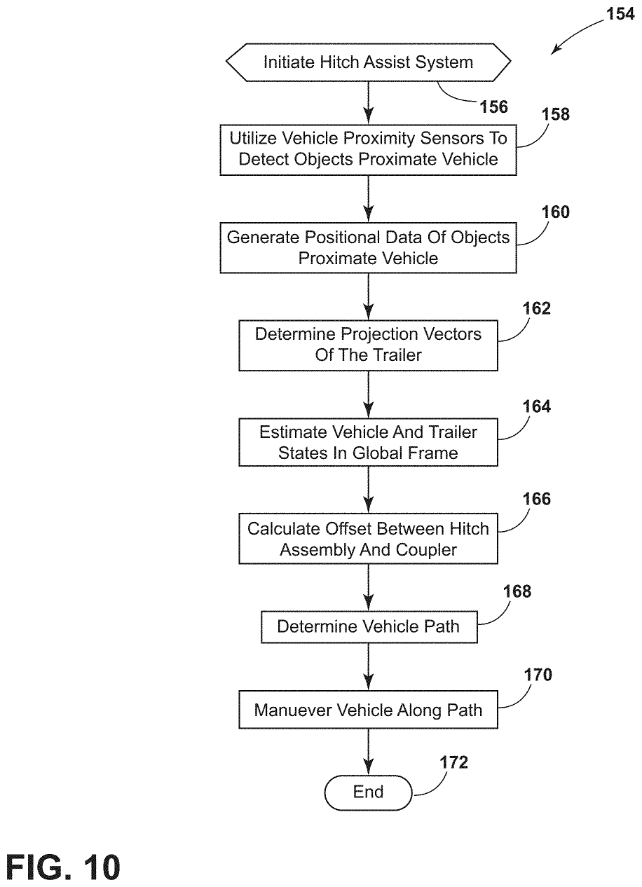

Referring to FIG. 10, a method 154 of aligning the hitch assembly 22 with the coupler 16 is shown, according to some examples. In particular, at step 156, the hitch assist system 10 is initiated. Upon initiation of the hitch assist system 10, the method continues to step 158, where one or more proximity sensors on the vehicle 12 generate sensor signals which may be correlated to the position of objects in the fields of view 64a, 64b, 64c, 64d (FIG. 7) of the proximity sensors based on the detection points 148, 150, 152 in the sensor signals. The sensor signals are provided to the controller 14 at step 160 for generating positional data of objects proximate the vehicle 12, map building, and/or localization/navigation (e.g., grid map 142 (FIG. 8)). Map building uses the measurements from the proximity sensors to measure and estimate the location of objects in the field of view 64a, 64b, 64c, 64d (FIG. 7) of the proximity sensors using techniques known to one of ordinary skill in the art. Localization/navigation estimates the kinematic state of the vehicle 12 and object positions in the global frame using techniques known to one of skill in the art. For example, in some examples, an extended Kalman filter is used to blend measurements from different sensors to estimate the kinematic state of the vehicle 12 and/or positional data of objects proximate the vehicle 12. The different sensors can include, but are not limited to, different types of radar sensors 64, as mentioned above, which provide measurements of the kinematic state of the vehicle 12. As used herein, the kinematic state of the vehicle 12 refers to the vehicle's position, velocity, attitude (three-dimensional orientation), angular velocity, and/or positional data of objects proximate the vehicle 12. A global frame is a reference frame that is based on the center 62 of the vehicle 12.

Once objects proximate the vehicle 12 are detected and mapped, as provided herein, through a SLAM process, or any other practicable method, the hitch assist system 10 attempts to distinguish points 148, 150, 152 indicative of a trailer 18 and/or a coupler 16 within the collected data by comparing to the database. For example, as discussed herein, the pair of points 148, 150 or corners of the trailer 18 may be equally laterally spaced from the coupler 16 forming a triangular pattern. This pattern may be indicative of a trailer 18 and thereby distinguished by the hitch assist system 10. Such a pattern may be used to calculate one or more characteristics of the trailer 18, such as a trailer heading direction and/or a position of the coupler 16.

At step 162, projection vectors are formed between detected positions or points 148, 150, 152 in the global frame. For example, projection vectors are formed between positions of at least three points 148, 150, 152 (and coupler 16) indicative of the trailer 18. The projection vectors may be indicative of the length of the coupler 16, the position of the coupler 16, and/or the heading direction of the coupler 16.

At step 164, the points 148, 150, 152 positions are calculated in the global frame by resolving the estimated object positions relative the vehicle 12 in the global frame. As step 166, the positions of the trailer 18 and/or the coupler 16 and the vehicle 12 are used to determine an offset between the hitch assembly 22 and the coupler 16. Once the offset is determined at step 166, the path derivation routine 128 can be used to determine the vehicle path 20 to align the hitch ball 26 with the coupler 16 at step 168. In this manner, the controller 14 uses the path derivation routine 128 to determine the path 20 to align the hitch ball 26 with the coupler 16 in an overlapping position over hitch ball 26. Once the path 20 has been derived, the hitch assist system 10 can ask the user U to relinquish control of at least the steering wheel 88 of vehicle 12 (and, optionally, the throttle 100 and brake, in various implementations of the hitch assist system 10 wherein the controller 14 assumes control of the powertrain control system 98 and the brake control system 96 during execution of the operating routine 130) while the vehicle 12 performs an auto hitch operation at step 170. When it has been confirmed that user U is not attempting to control steering system 80 (for example, using the torque sensor 94), the controller 14 begins to move vehicle 12 along the determined path 20. Furthermore, the hitch assist system 10 may determine if the transmission system 102 is in the correct gear and may shift to the desired gear or prompt the user U to shift to the desired gear. The hitch assist system 10 may then control the steering system 80 to maintain the vehicle 12 along the path 20 as either the user U or the controller 14 controls the speed of vehicle 12 using the powertrain control system 98 and the braking control system 96. Once hitch ball 26 is aligned with the coupler 16, the method 154 ends at step 172.

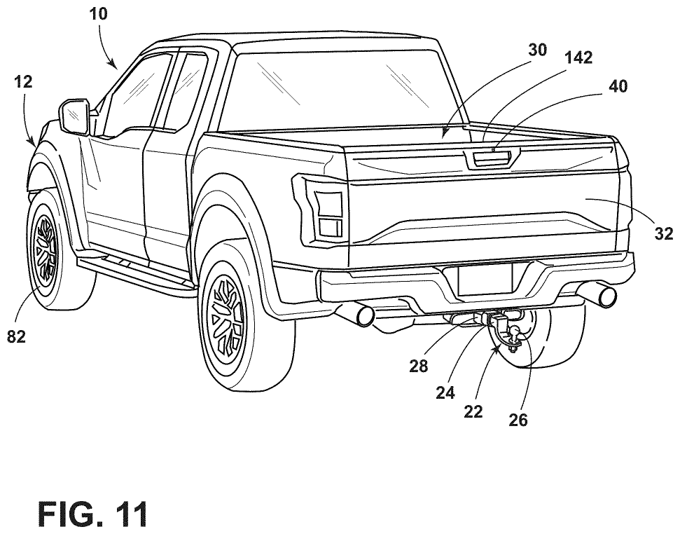

Referring to FIGS. 11-13, in some examples, the rear imager 40 may be disposed within the tailgate 32, or any other rear portion of the vehicle 12, and configured to provide image data 56 rearwardly of the vehicle 12. The imager 40 may be capable of imaging a top view of the hitch ball 26 and can provide the image data 56 to the controller 14 for use by the image processing routine 58 (by the process described above or by other available processes) to determine the height H_{hb} of hitch ball 26 and/or a length L_{bm} of ball mount 24 which may even be possible in low visibility conditions due to the proximity of the hitch assembly 22 to the rear imager 40. Once a height of the hitch ball 26 is determined, the hitch assist system 10 can store the height H_{hb} of that distinct hitch ball 26 for future use, possibly without having to measure various characteristics of the ball mount 24 and hitch ball 26 during subsequent hitch assist operations.

Due to the wide variety of ball mounts 24 and hitch balls 26, or connectors, that may be utilized, the hitch assist system 10 may utilize the one or more imagers 38, 40, 42, 44 to determine various characteristics of the hitch assembly 22, including the ball mount length L_{bm} and/or the hitch ball height H_{hb}. In some examples, during an initial setup routine for the hitch assist system 10, the user U can be prompted to install the hitch assembly 22 to the vehicle 12 by way of assembling a ball mount 24 including the hitch ball 26 within the receiver 28 positioned on the rear of vehicle 12.

If no hitch assemblies are stored within the memory 126 or the hitch assembly 22 attached to the vehicle 12 is unrecognized when compared to any previously attached and recognized hitch assemblies, the user can then be asked to input a diameter of the hitch ball 26. The diameter D_{hb} of the hitch ball 26 is stored within the memory 126 and may be used as a reference length for determining various other measurements about the vehicle 12. In some examples, the imager 40 may capture a series of still images proximate the rear portion of the vehicle 12. As previously described, the images include portions of the vehicle 12, objects affixed to the vehicle 12 (e.g., the hitch assembly 22), and/or noise (e.g., ground trash, animals, etc.).

The number of captured images and/or the time elapsed in between capturing images may be predetermined. The predetermined number of captured images may, as described below, depend on pixel or intensity values of an averaged or combined image. The controller 14 may average or combine the captured images into an averaged or combined image patch 54 through usage of the processor 124. In general, the averaging process includes averaging the pixels of the series of captured images after optionally stabilizing the images (i.e., aligning them to account for slight vibrations by the imager 40). The controller 14 may find outer edges of objects within the averaged or combined image. The controller 14 finds the outer edges by analyzing the averaged or combined image. In general, the analyzing process involves determining an interface between items statically affixed to the vehicle 12 and blurred background noise. The controller 14 associates specific pixels on the averaged image with a real-world spatial position, which includes a known reference length, such as the diameter of the hitch ball 26. Thus, the controller 14 may determine dimensions of objects defined by specific pixels. For example, the length L_{bm} of the ball mount 24 is compared to the diameter D_{hb} of the hitch ball 26 to determine the length L_{bm} of the ball mount 24 by comparing the number of pixels. It will be appreciated, however, that the length L_{bm} of the ball mount 24 may also be calculated by other sensors or modules in the vehicle 12 using any distance measuring technique.

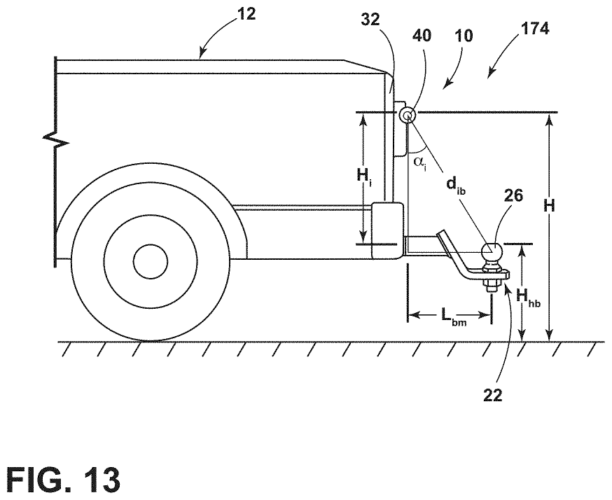

Referring to FIG. 13, an imager model 174 is shown generally representing the rear imager 40 in relation to the hitch assembly 22 in which projective geometry of the imager 40 may be used to determine a height H_{hb} of the hitch ball 26. As depicted, αᵢ denotes the hitch ball viewing angle of the rear imager 40, d_{ib} denotes the distance between the rear imager 40 and the hitch ball 26, H denotes the height of the rear imager 40 relative to the ground, H_{hb} denotes a height of the hitch ball 26 relative to the ground, Hᵢ denotes a height of the rear imager 40 relative to the hitch ball 26, and L_{bm} is the distance between the hitch ball 26 and the vehicle 12.

From the imager model 174, a length of the ball mount 24 and the distance d_{ib} between the rear imager 40 and the hitch ball 26 is provided by the following equation:

d_{ib}=C*(D_{hb(pixels))}⁻¹ (6)

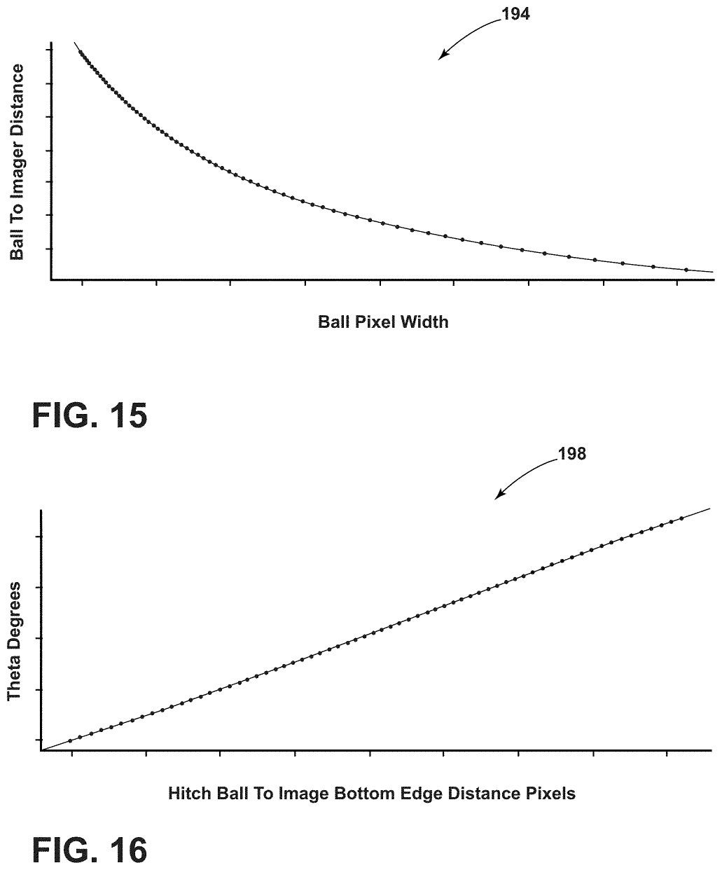

In equation 6, D_{hb (pixels)} is the diameter of the hitch ball 26 measured by pixels, which is known from the image processing described above and C corresponds to a constant, which is known. The constant C varies for different vehicle platforms (due to different camera positions, resolutions, etc.), and may be determined based on a calibration analysis on an instance of a vehicle setup and stored within the memory 126. For example, FIG. 15 illustrates an exemplary graph 194 of the diameter D_{hb (pixels)} of the hitch ball 26 measured by pixels correlated to a denoted distance d_{ib} between the rear imager 40 and the hitch ball 26. Once the distance d_{ib} between the rear imager 40 and the hitch ball 26 is determined, the height Hᵢ between the hitch ball 26 and the rear imager 40 may be determined by the following equation:

$${H}_{c} = \sqrt{{d}_{ib}^{2} - {L}_{bm}^{2}} \qquad ( 7 )$$

In equation 7, d_{ib} and L_{bm} are assumed known. Since the height H of the rear imager 40 in relation to the ground is known, the height H_{hb} of the hitch ball 26 can be obtained by subtracting the height Hᵢ between the hitch ball 26 and the rear imager 40 from the height H of the rear imager 40 relative a ground surface. In some instances, additional payload may be disposed within the vehicle 12 causing a change in the height H of the rear imager 40 relative to the ground. This can be accounted for through any practicable method including calculating the new height H of the rear imager 40 relative the ground through various image-processing techniques and/or through any other sensor that may be disposed on any portion of the vehicle 12.

Moreover, the hitch ball 26 viewing angle αᵢ may be calculated based on the following equation

$$\frac{{L}_{bm}}{sin ( {α}_{i} )} = \frac{{d}_{ib}}{sin ( 90 )} \qquad ( 8 )$$

In equation 8, d_{ib} and L_{bm} are assumed known. Accordingly, the hitch ball-viewing angle may be calculated using the law of sines. Additionally and/or alternatively, a lookup table and/or graph 198 may be used, as exemplarily illustrated in FIG. 16, for correlating a hitch ball 26 to imager distance d_{ib}, which may be measured in pixel length, to a hitch ball viewing angle αᵢ.

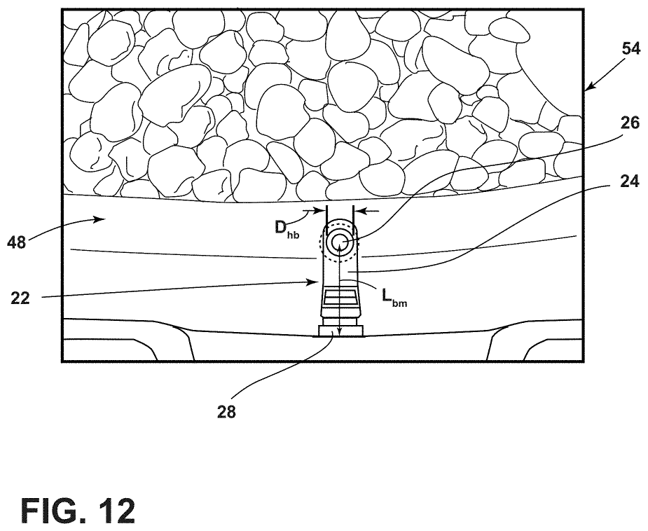

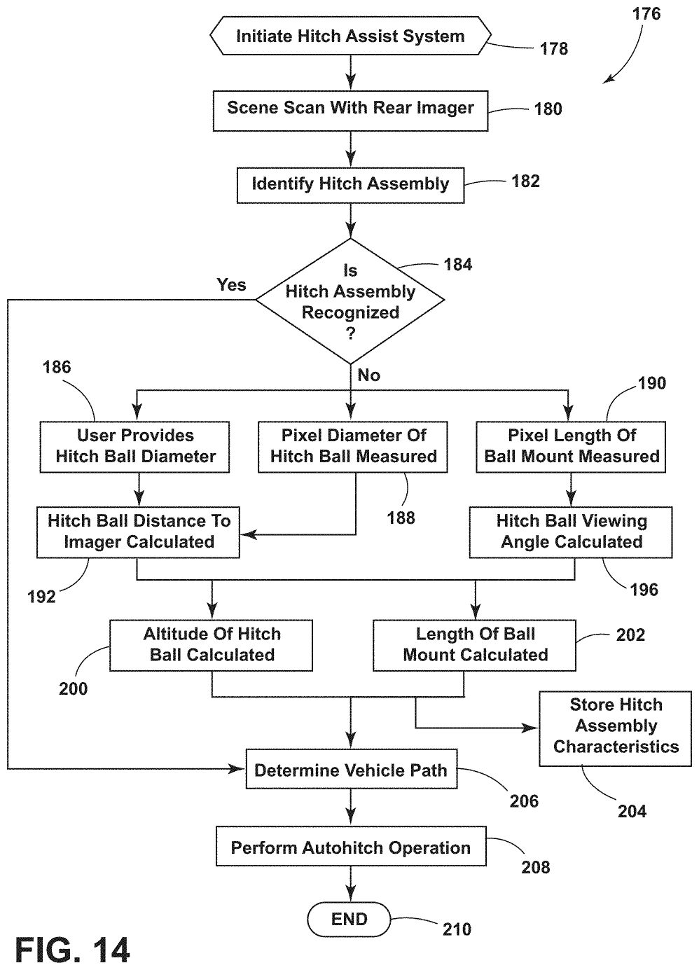

Turning now to FIG. 14, a method 176 showing steps in using the hitch assist system 10 to align the vehicle hitch ball 26 with the trailer coupler 16 is shown, according to some examples. In particular, in step 178, the hitch assist system 10 is initiated. Once the hitch assist system 10 is initiated, the controller 14 can use imaging system 36 to scan the viewable scene using any or all available imagers 38, 40, 42, 44 in step 180. The scene scan, at step 180, can create the image patch 54 (FIG. 12) that may be used to then identify the hitch assembly 22 at step 182. As provided herein, the memory 126 of the controller 14 may store various characteristics of recognized hitch assemblies, including the length of the ball mount 24 and/or the height H_{hb} of the hitch ball 26. Once the imaging system 36 detects the hitch assembly 22, the hitch assist system 10 will determine if the hitch assembly 22 is recognized at step 184 thereby having the characteristics of that hitch assembly 22 stored in the memory 126 or if the hitch assembly 22 is newly installed on the vehicle 12 or is unrecognized.

If the various characteristics of the hitch assembly 22 are not stored in the memory 126, the user may be asked to provide the diameter D_{hb} of the hitch ball 26 at step 186. The hitch ball diameter D_{hb} may be entered into the hitch assist system 10 through any practicable device, such as the HMI 114 (FIG. 2) and/or a portable device 122 (FIG. 1). At steps 188 and 190, respectively, the pixel diameter of the hitch ball 26 and the pixel length of the ball mount 24 are measured. To measure the pixel diameter of the hitch ball 26, the processor 124 applies an image undistortion and homography transformation to generate a top-down view of images captured by the imager 40. Then, the processor 124 may apply a Hough circular transform using a parametric circle function to locate circular structures. In so doing, the hitch ball 26, having a circular shape, may be more easily identified and distinguished from other structures proximate the vehicle 12. Upon identifying the circular structure, the controller 14 through the processor 124, applies a filter (e.g., a Kalman filter) to the circular structure. Upon detection of the circular structure, the number of pixels forming a diameter of the structure may be measured. Based on the measured amount of pixels and the inputted value from the user at step 186, the diameter D_{hb} of the hitch ball 26 may be converted to number of pixels within the image patch 54 (FIG. 12). Likewise, the ball mount 24 may be identified through image processing and the number of pixels along the length of the ball mount 24 may also be measured.

At step 192, with the known diameter D_{hb} of the hitch ball 26, and the measured pixel diameter, the hitch assist system 10 may be able to calculate the distance d_{ib} between the rear imager 40 and the hitch ball 26, or the focal length. In some instances, a formula or lookup table relating camera resolution, the distance d_{ib} between the rear imager 40 and the hitch ball 26, camera position, and/or hitch ball 26 width may be stored in the memory 126. In other examples, a lookup table including data relating hitch ball 26 position to pixel width of the hitch ball 26 as various discrete hitch ball 26 widths may be stored within the memory 126 forming a data driven formula. For example, FIG. 15 illustrates an exemplary graph 194 of the pixel width of the hitch ball 26 and a distance d_{ib} from the hitch ball 26 to the imager 40, which may be exponential and/or asymptotic.

At step 190, the hitch assist system 10 may also store the number of pixels included in the drawbar, which may be identified through various image-processing techniques. In some instances, a fixed point on the image patch 54 may be used as the reference origin, which may be horizontally centered on the image. For example, the reference origin may be a pixel on the ball mount 24 that is proximate the bumper. Then, the system measures the number of pixels between this point and the center of the hitch ball 26.

At step 196, the length L_{bm} of the ball mount 24 may be used to determine the angle of the hitch ball 26 relative to the rear imager 40, which may be referred to as the viewing angle. As provided herein, a data-driven formula and/or lookup table may be used to determine the viewing angle. For example, the lookup table may include data for various hitch ball diameters D_{hb}, various distances between the rear imager 40 and the hitch ball 26, and/or various viewing angles. In some instances, the viewing angle may be predicted based upon the pixel width of the ball mount 24. Moreover, a lookup table and/or graph 198 may be used, as exemplarily illustrated in FIG. 16, for correlating a hitch ball 26 to imager distance d_{ib}, which may be measure in pixel length, to a hitch ball viewing angle αᵢ. However, it will be appreciated that the length L_{bm} of the ball mount 24 and the viewing angle may be determined through any other process without departing from the teachings provided herein.

At steps 200 and 202, the altitude of the hitch ball 26, relative the ground surface, and the length L_{bm} of the ball mount 24 can be determined using the available image data 56 as discussed above, including using the image processing routine 58. The new hitch assembly data may then be stored in the memory 126 of the controller 14 for later hitch assist operations utilizing the same hitch assembly 22 at step 204.

At step 206, the path derivation routine 128 can be used to determine the vehicle path 20 to align the hitch ball 26 with the coupler 16. In this manner, the controller 14 uses the path derivation routine 128 to determine the path 20 to align the hitch ball 26 with the coupler 16 in an overlapping position over hitch ball 26. Once the path 20 has been derived, the hitch assist system 10 can ask the user U to relinquish control of at least the steering wheel 88 of vehicle 12 (and, optionally, the throttle 100 and brake, in various implementations of the hitch assist system 10 wherein the controller 14 assumes control of the powertrain control system 98 and the brake control system 96 during execution of the operating routine 130) while the vehicle 12 performs an auto hitch operation at step 208. When it has been confirmed that user U is not attempting to control steering system 80 (for example, using the torque sensor 94), the controller 14 begins to move vehicle 12 along the determined path 20. Furthermore, the hitch assist system 10 may determine if the transmission system 102 is in the correct gear and may shift to the desired gear or prompt the user U to shift to the desired gear. The hitch assist system 10 may then control the steering system 80 to maintain the vehicle 12 along the path 20 as either the user U or the controller 14 controls the velocity of vehicle 12 using the powertrain control system 98 and the braking control system 96. As discussed herein, the controller 14 or the user U can control at least the steering system 80, while tracking the position of the coupler 16 until the vehicle 12 reaches the endpoint 132, wherein the vehicle hitch ball 26 reaches the desired position 140 for the desired alignment with the coupler 16, at which point the method can end at step 210.

A variety of advantages may be derived from the use of the present disclosure. For example, use of the disclosed hitch assist system provides a system for determining a hitch ball height and/or location for use in aligning the hitch ball with a coupler of a trailer. Furthermore, the hitch assist system may utilize any type of sensors for producing an object detection grid map. In response to the grid map, the hitch assist system may be capable of identifying a trailer and/or a coupler proximate to the vehicle. With the known hitch ball location, the hitch assist system may be capable of aligning the hitch ball with the detected coupler.

According to some examples, a hitch assist system is provided herein. The hitch assist system includes a sensing system having an imager and a proximity sensor. The hitch assist system further includes a controller for receiving signals from the proximity sensor and generating a feature map; determining a coupler location based on detected features; and maneuvering a vehicle along a path to align a hitch ball with a coupler of a trailer. Examples of the hitch assist system can include any one or a combination of the following features:
the controller is further configured to generate an image patch proximate the vehicle and determine a hitch ball height;
the proximity sensor is a radio detection and ranging (radar) sensor;
the controller is further configured to apply a parametric circle function to locate circular structures within the image patch;
the controller is further configured to compare an inputted value of a hitch ball diameter to a number of pixels within the circular structure to form a reference length;
the controller is further configured to utilize the reference length to determine a ball mount length based on a number of pixels along a longitudinal axis of the ball mount compared to the number of pixels within the circular structure that forms the reference length;
the controller uses sensor signals from the proximity sensor to conduct a simultaneous localization and mapping (SLAM) process of an area proximate the vehicle;
the SLAM process is configured to locate one or more points on a trailer and the one or more points are used to determine a characteristic of the trailer;
the one or more points include a first point indicative of the coupler, a second point indicative of a first corner of the trailer, and a third point indicative of a second corner of the trailer; and/or
a length of the coupler is calculated based on a relationship between the first, second, and third points.

Moreover, a hitch assist method is provided herein. The method includes generating a grid map of features proximate a vehicle from one or more sensors disposed on the vehicle. The method also includes localizing and mapping two or more features relative to one another indicative of a trailer. The method further includes controlling a vehicle along a path to align a hitch ball with a coupler of the trailer. Examples of the hitch assist method can include any one or a combination of the following features and/or steps:
collecting and storing feature location for classification of the two or more features; and analyzing the two or more features to form a feature extraction database;
the feature extraction database stores the two or more features for iterative comparison to new data for predicting the presence of a predefined object based on detected features;
computing features of the feature extraction database using a scale-invariant feature transform (SIFT) or Harris corner detectors;
computing features of the feature extraction database using a Harris corner detector;
creating an image patch of a scene rearwardly of the vehicle;
applying a parametric circle function to locate circular structures within the image patch;
comparing an inputted value of a hitch ball diameter to a number of pixels within the circular structure to form a reference length; and/or
utilizing the reference length to determine a ball mount length or a hitch ball height

According to various examples, a hitch assist system is provided herein. The hitch assist system includes an imager for capturing rear-vehicle images. The hitch assist system further includes a controller for creating an image patch of a scene rearwardly of the vehicle based on images provided by the imager; applying a parametric circle function to locate circular structures within the image patch; comparing an inputted value of a hitch ball diameter to a number of pixels within the circular structure to form a reference length; and utilizing the reference length to determine a ball mount length or a hitch ball height. Examples of the hitch assist system can include any one or a combination of the following features:
a proximity sensor configured to generate a grid map of features proximate a vehicle from one or more sensors disposed on the vehicle;
the controller identifies a circular structure as representing a hitch ball and applies a filter to the circular structure; and/or
the controller identifies a central point within the circular structure and measures a pixel length from a bumper to the central point for calculating the ball mount length,

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

Implementations of the systems, apparatuses, devices, and methods disclosed herein may include or utilize a special-purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general-purpose or special-purpose computer system. Computer-readable media that store computer-executable instructions are computer storage media (devices). Computer-readable media that carry computer-executable instructions are transmission media. Thus, by way of example, and not limitation, implementations of the present disclosure can include at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

An implementation of the devices, systems, and methods disclosed herein may communicate over a computer network. A “network” is defined as one or more data links that enable the transport of electronic data between computer systems and/or modules and/or other portable devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general-purpose or special-purpose computer. Combinations of the above should also be included within the scope of computer-readable media.

Computer-executable instructions include, for example, instructions and data, which, when executed at a processor, cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through the network, both perform tasks. In a distributed system environment, program modules may be located in both local and remote memory storage devices.

Further, where appropriate, functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It will be noted that the sensor examples discussed above might include computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Examples of the present disclosure may be implemented in further types of devices, as would be known to persons skilled in the relevant art(s).

At least some examples of the present disclosure have been directed to computer program products including such logic (e.g., in the form of software) stored on any computer usable medium. Such software, when executed in one or more data processing devices, causes a device to operate as described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It will be noted that the elements and/or assemblies of the system might be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A hitch assist system comprising:
a sensing system having an imager and a proximity sensor; and
a controller for:
receiving signals from the proximity sensor and generating a feature map;
determining a coupler location based on detected features; and
maneuvering a vehicle along a path to align a hitch ball with a coupler of a trailer.

2. The hitch assist system of claim 1, wherein the controller is further configured to generate an image patch proximate the vehicle and determine a hitch ball height.

3. The hitch assist system of claim 1, wherein the proximity sensor is a radio detection and ranging (radar) sensor.

4. The hitch assist system of claim 2, wherein the controller is further configured to apply a parametric circle function to locate circular structures within the image patch.

5. The hitch assist system of claim 4, wherein the controller is further configured to compare an inputted value of a hitch ball diameter to a number of pixels within the circular structure to form a reference length.

6. The hitch assist system of claim 5, wherein the controller is further configured to utilize the reference length to determine a ball mount length based on a number of pixels along a longitudinal axis of the ball mount compared to the number of pixels within the circular structure that forms the reference length.

7. The hitch assist system of claim 1, wherein the controller uses sensor signals from the proximity sensor to conduct a simultaneous localization and mapping (SLAM) process of an area proximate the vehicle.

8. The hitch assist system of claim 7, wherein the SLAM process is configured to locate one or more points on a trailer and the one or more points are used to determine a characteristic of the trailer.

9. The hitch assist system of claim 8, wherein the one or more points include a first point indicative of the coupler, a second point indicative of a first corner of the trailer, and a third point indicative of a second corner of the trailer.

10. The hitch assist system of claim 8, wherein a length of the coupler is calculated based on a relationship between the first, second, and third points.

11. A hitch assist method comprising the steps of:
generating a grid map of features proximate a vehicle from one or more sensors disposed on the vehicle;
localizing and mapping two or more features relative to one another indicative of a trailer; and
controlling a vehicle along a path to align a hitch ball with a coupler of the trailer.

12. The hitch assist method of claim 11, further comprising:
collecting and storing feature location for classification of the two or more features; and
analyzing the two or more features to form a feature extraction database.

13. The hitch assist method of claim 12, wherein the feature extraction database stores the two or more features for iterative comparison to new data for predicting the presence of a predefined object based on detected features.

14. The hitch assist method of claim 12, further comprising:
computing features of the feature extraction database using a scale-invariant feature transform (SIFT) or Harris corner detectors.

15. The hitch assist method of claim 12, further comprising:
computing features of the feature extraction database using a Harris corner detector.

16. The hitch assist method of claim 11, further comprising:
creating an image patch of a scene rearwardly of the vehicle;
applying a parametric circle function to locate circular structures within the image patch;
comparing an inputted value of a hitch ball diameter to a number of pixels within the circular structure to form a reference length; and
utilizing the reference length to determine a ball mount length or a hitch ball height.

17. A hitch assist system comprising:
an imager for capturing rear-vehicle images; and
a controller for:
creating an image patch of a scene rearwardly of the vehicle based on images provided by the imager;
applying a parametric circle function to locate circular structures within the image patch;
comparing an inputted value of a hitch ball diameter to a number of pixels within the circular structure to form a reference length; and
utilizing the reference length to determine a ball mount length or a hitch ball height.

18. The hitch assist system of claim 17, further comprising:
a proximity sensor configured to generate a grid map of features proximate a vehicle from one or more sensors disposed on the vehicle.

19. The hitch assist system of claim 17, wherein the controller identifies a circular structure as representing a hitch ball and applies a filter to the circular structure.

20. The hitch assist system of claim 18, wherein the controller identifies a central point within the circular structure and measures a pixel length from a bumper to the central point for calculating the ball mount length.
